(19) United States
(12) Patent Application Publication
(10) Pub. No.: US 2005/0105195 A1
(43) Pub. Date: May 19, 2005

(54) Vehicle rear-view range finder or vehicle blind-zone range finder

(76) Inventor: Robert Saunders Sherry, Asheville, NC (US)

Correspondence Address: Robert S. Sherry, 29 Parkman Place, Asheville, NC, 28806, US

(21) Appl. No.: 10/714,043

(22) Filed: Nov. 17, 2003

(51) Int. Cl. G02B 5/08

(52) U.S. Cl. 359/854; 359/850

(57) ABSTRACT

A second mirror appended to an existing rear-view mirror, set to provide an “at a glance” determination of the relative position of a vehicle or obstruction to the rear. The add-on mirror is aimed at a specific point on the road to the rear chosen by the driver to provide safe clearance for his vehicle when pulling in after passing or while backing up. If an object visible in the primary rear-view mirror does not show in the add-on mirror, the vehicle or obstruction is beyond the pre-selected range. If visible in both mirrors, the object is at less than the selected range. The driver is provided with “hard” information on position without having to guess based on the distorted image presented by a single mirror.

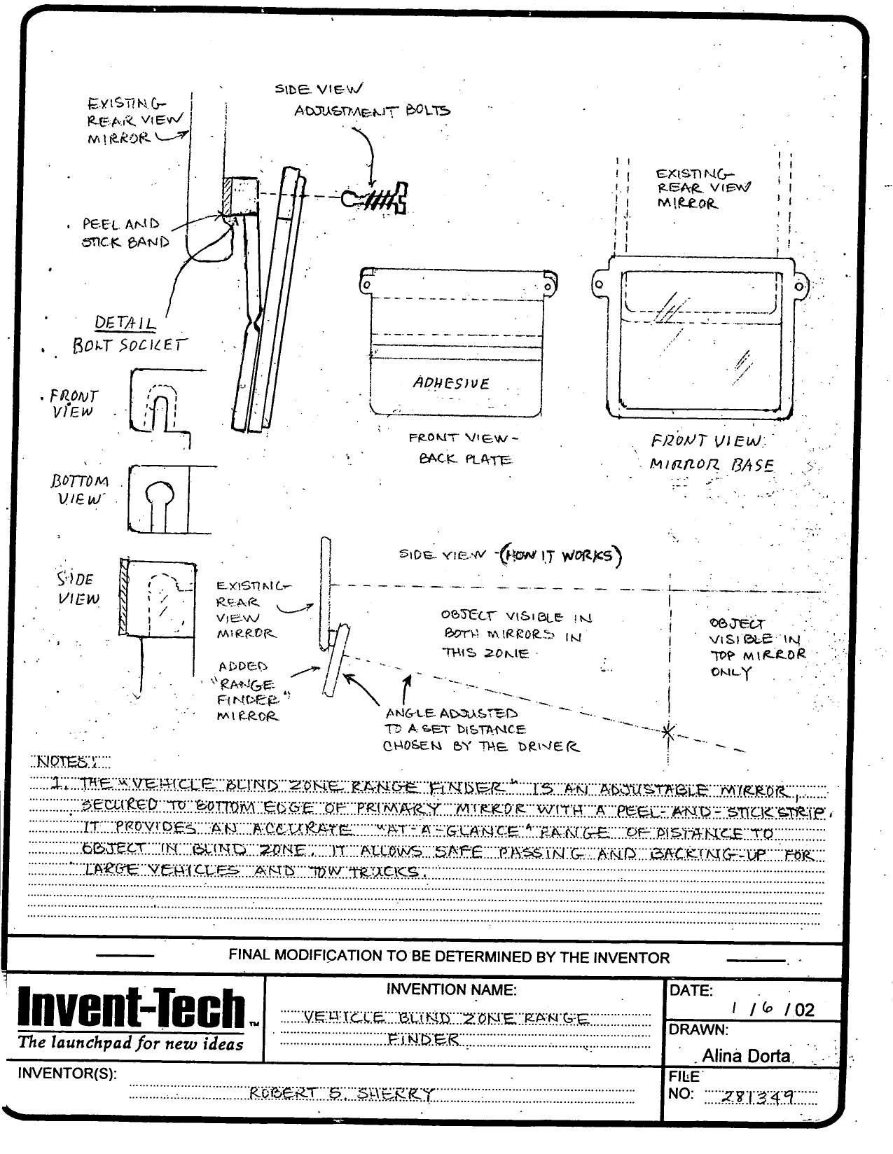

### CROSS REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION—FIELD OF INVENTION

This invention relates to the problem of judging distance while driving using the rear-view mirror to monitor surrounding traffic or identifying obstacles while backing.

### BACKGROUND OF THE INVENTION

The Vehicle Rear-View Range Finder addresses the problem faced by a driver towing a trailer or driving a larger vehicle such as a rental van or a semi-trailer and thus deprived of the use of the internal center-mounted rear-view mirror. It is difficult to judge distance while using a mirror. Vehicle manufacturers recognize the problem and commonly label the exterior rear-view mirrors with the warning “Caution: Objects in the mirror are closer than they appear.” Accurate distance information is critical when negotiating traffic or backing up. The Vehicle Rear-View Range Finder provides an at-a-glance conformation of distance for an object visible in the rear-view mirror depending upon the range pre-selected by the driver.

The basic concept is that of the optical split-image range finder which came into use with the military prior to World War I and may be considered as public domain considering its age. The optical-split image range finder operates by measuring the angle between the lines of sight of two mirrors separated by a known distance and focused on the same object. The measured angle is then mathematically converted to read out as a range on a pre-calibrated scale.

The Vehicle Rear-View Range Finder applies the split-image concept in reverse. Rather than determining the precise range to an object visible in the mirror, it reports the position of that object as being short of, or beyond a pre-selected distance. This tells the driver when it is safe to pull back in after passing on the highway or when to stop while backing toward an obstacle. It takes the guess work out of determining distance using a mirror.

The Vehicle Rear-View Range Finder is an adjustable second mirror (hereafter the secondary mirror) attached to the lower edge of an existing rear-view mirror (hereafter the primary mirror) and adjusted to aim on a slightly lower line of sight at a specific point on the ground behind the vehicle. An object visible in both mirrors is inside the pre-selected range. An object visible in the primary mirror only is beyond the pre-selected range. (See Illustration: How it works.)

The manual version of the Vehicle Rear-View Range Finder consists of a flat mirror, a rigid mounting plate for the mirror and a backing plate designed to bend slightly along the horizontal centerline The mirror mount and the backing plate are then secured to each other using adhesive to join the lower halves only. The mirror is then secured to the face of the mirror mounting plate using adhesive. Adjustment screws pass through the edges of the mirror mounting plate to engage slots molded into the backing plate. Raised ridges at the upper rear edge of the backing plate are coated with adhesive to allow the user to mount the completed Vehicle Rear-View Range Finder depending from the lower edge of the primary rear-view mirror on his vehicle.

The Vehicle Rear-View Range Finder is adjusted for use by placing any visible object on the ground to the rear of the vehicle including trailer at a distance considered by the user to be a safe interval for returning to the right lane after passing. The user then checks the field of view of his primary mirror and turns the adjusting screws of the range finer until the target object is barely visible at the upper edge of the secondary mirror as viewed from the driver's position at the steering wheel. The unit is then ready for use.

A computer search of patent files back to 1976 using the paired search definitions “optical” and “range finder” revealed only high-tech systems for determining what an unknown range might be. The Vehicle Rear-View Range Finder is a decidedly low-tech system which reports in very simple terms the position of an object visible in a mirror relative to a pre-set distance.

A patent search using “vehicle blind-zone” and “range finder” produced no match.

A search using “vehicle” and “blind-zone” produced a single hit, U.S. Pat. No. 4,793,701, Brown, 1988, which Claims an attachable second mirror similar to my concept, but the claim is limited to widening the visible area horizontally and contains no mention of range-finding capability. Physical design is similar but the purpose is different.

1. A device utilizing a reversed application of the of the split-image range-finder concept tailored for use in quickly and accurately reporting the relative distance of another vehicle or an obstacle visible in a vehicle rear-view mirror.

2. The device in claim 1 is composed of plastic or other moldable material to form an adjustable carrier for an add-on mirror attached to the lower edge of an existing vehicle rear-view mirror mounted on a vehicle, either internally or externally.

3. Said device in claim 1 is adjustable by the vehicle operator, either manually or by remote control.

4. The device in claim 1 makes use of two divergent lines of sight, approximately horizontal determined by the setting of a primary rear-view mirror, and a second line of sight determined by the setting of the add-on mirror attached to the lower edge of the primary mirror and adjusted to reflect an image of a specific point selected by the user to the rear of the vehicle.

5. The combined existing and add-on mirrors above provide two views to the rear showing the object vehicle or obstruction in the primary mirror, and, by the presence or absence of that image in the add-on mirror, precisely reporting the position of the vehicle or obstruction relative to the selected point in the rear.
